(19) United States
(12) Patent Application Publication
(10) Pub. No.: US 2006/0214765 A1
(43) Pub. Date: Sep. 28, 2006

(54) Wireless transmission tag

(76) Inventors: Stephen M. Pitchers, REDHILL (GB); Brian J. Guthrie, Crawley (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/547,946

(22) PCT Filed: Feb. 20, 2004
(86) PCT No.: PCT/IB04/00537

§ 371 Date: Sep. 6, 2005

(30) Foreign Application Priority Data
Mar. 4, 2003 (GB) 0304841.0

(51) Int. Cl. G05B 23/02

(52) U.S. Cl. 340/3.4; 340/10.1

(57) ABSTRACT

A wireless transmission tag (100) has a memory (110) coupled to an antenna (130) via control circuitry (120). The memory (110) typically stores data to be transmitted by the wireless transmission tag (100). The control circuitry (120), which may comprise a first circuit portion (122) and a second circuit portion (124), is powered by a power source (140). The power source (140) is coupled to a sensor (150), and is arranged to activate the power supply to at least a part of the control circuitry (120) upon the detection of an external stimulus by the sensor (150). This way, a wireless transmission tag (100) is provided that only starts transmitting data when activated by a predefined stimulus.

The present invention relates to a wireless transmission tag.

The present invention also relates to a product fitted with a wireless transmission tag.

The present invention further relates to a communication system including a product tagged with a wireless transmission tag.

The present invention further relates to a method for controlling an electronic device of a communication system including a wireless transmission tag.

Wireless tags, and in particular radio frequency (RF) tags are becoming increasingly popular as a product information source, not in the least because the tags are relatively small and cheap to manufacture, which enables the widespread use of wireless transmission tags in business as well as domestic applications.

In most application domains, the wireless tags used will be active tags, transmitting the product information either continuously or intermittently. The use of such transmission tags implies that the electronic device that is intended as the recipient of the product information only has to be fitted with a receiver, which is advantageous in terms of cost of the electronic device. This is particularly relevant in application domains where it often is not the primary task of the electronic device to communicate with the tag, like the domestic application domain, where the receivers may be integrated into domestic appliances.

However, the increasing popularity of the wireless transmission tag as a product information source causes some significant complications. With an increase of the number of wireless transmission tags in an area, the number of different transmissions is likely to increase as well. This is likely to cause destructive interference between the transmission signals form the various wireless transmission tags, especially when they share the same transmission frequency range. Such interference obviously is highly unwanted, because it will lead to significant delays in the reception of the transmitted information, or even cause the failure of such a reception.

It is an object of the present invention to provide a wireless transmission tag that reduces the chance of the occurrence of destructive interferences with other wireless transmission tags.

It is another object of the present invention to provide a product tagged with a wireless transmission tag that reduces the chance of the occurrence of destructive interferences with other wireless transmission tags.

It is another object of the present invention to provide a communication system including a wireless transmission tag that benefits from the reduced chance of the occurrence of destructive interferences with other wireless transmission tags.

It is yet another object of the present invention to provide a method for controlling for controlling an electronic device of a communication system including a wireless transmission tag where the measures to reduce the chance of the occurrence of destructive interferences with other wireless transmission tags are exploited.

According to a first aspect of the invention, there is provided a wireless transmission tag having a memory, control circuitry coupled to the memory, an antenna coupled to the control circuitry and a power source for powering the control circuitry, the power source being coupled to a sensor for activating a power supply from the power source to at least a part of the control circuitry responsive to an external stimulus.

The invention is based on the realization that the vast majority of wireless transmission tags contain information that typically is required once or a few times at most, making it unnecessary that the wireless transmission tag frequently outputs the information. In addition, the moment the information actually is required is in many cases linked to an external stimulus, like the opening of a tagged product, the insertion of a tagged product into a microwave, a tagged product being probed by some reader like a bar code reader and so on. Therefore, the wireless transmission tag only has to send its information when this external stimulus takes place. To this end, the wireless transmission tag is fitted with a sensor for detecting the external stimulus, after which it activates the wireless transmission tag. This not only has the advantage that a significant reduction in data traffic from the various wireless transmission tags is achieved, thus reducing the risk of destructive interference, but it has the additional advantage that the wireless transmission tag becomes more power efficient, because the wireless transmission tag only transmits its information when activated by the sensor.

In an embodiment, the sensor is coupled to the power source via the control circuitry, and the control circuitry comprises a first circuit portion for controlling a data transfer from the memory to the antenna and a second circuit portion for activating a power supply from the power source to the first circuit portion in response to an output signal of the sensor.

This has the advantage that the power supply is not directly coupled to the sensor, and can be used in a low-power mode to power the part of the control circuitry that interprets the sensor readings.

At this point, it is noted that PCT patent application WO 02/07084 describes a RF wireless transponder tag, which is fitted with a sensor and which is attached to the seal of some form of packaging. The sensor is used to sense the opening of the packaging, which triggers the storage of data in the memory of the RF transponder tag. This data can be retrieved from the memory upon the next interrogation of the RF transponder tag by a transceiver, thus disclosing the opening of the packaging. It is emphasized that PCT patent application WO 02/07084 teaches a sensor-triggered modification of the information stored in a passive tag to flag the occurrence of an event. However, it does not teach the use of a sensor to wake up an active tag, that is, a wireless transmission tag, to reduce the risk of destructive interference between the transmissions of such tags. In addition, apart from the earlier mentioned disadvantages of using passive tags in certain application domains, a serious drawback of the measures disclosed in PCT patent application WO 02/07084 is that the original information is overwritten by the sensor-triggered information, which renders these measures unsuitable for application in the application domains targeted by the present invention.

According to a second aspect of the invention, there is provided a product tagged with a wireless transmission tag having a memory, control circuitry coupled to the memory, an antenna coupled to the control circuitry, and a power source for powering the control circuitry, the power source being coupled to a sensor for activating a power supply from the power source to at least a part of the control circuitry responsive to an external stimulus, the product comprising means for triggering the external stimulus.

This is advantageous in situations where the external stimulus has to be user-controlled, because the product has to maintain in an original state but the information transfer from the wireless transmission tag has to take place as well. To this end, the user may modify the means to trigger a sensor reading.

According to a third aspect of the present invention, there is provided a communication system comprising a product tagged with a wireless transmission tag having a memory, control circuitry coupled to the memory, an antenna coupled to the control circuitry and a power source for powering the control circuitry, the power source being coupled to a sensor for activating a power supply from the power source to at least a part of the control circuitry responsive to an external stimulus, and an electronic device comprising a processing unit and a receiver coupled to the processing unit, the processing unit being arranged to perform an operation relating to the external stimulus responsive to the reception by the receiver of data being transmitted by the wireless tag upon detection of the external stimulus.

The occurrence of a specific event leading to the external stimulus that triggers the transmission of the data by the wireless transmission tag may be the indication of the necessity to terminate some form of processing of the product by the electronic device, or may be caused by a change in a state of the product, which requires the electronic device to act upon that change. The data sent by the wireless transmission tag is delivered to the electronic device at the moment the electronic device is required to perform an action, which relates to the occurrence of the external stimulus. Therefore, it is advantageous if the data carried by the wireless transmission tag is intended to trigger this action, for instance by being some form of an instruction for the electronic device.

In an embodiment of the communication system, the electronic device is coupled to a network and the operation comprises sending information over the network.

This is for instance advantageous when the data from the wireless transmission tag indicates that the product is being used, in which case the information transmitted by the electronic device in response to this data can be targeted to preventing that a user runs out of the product by sending the information to the supplier of the product. This can be useful for domestic essentials as well as for medication, to name but a few applications.

According to a fourth aspect of the invention, there is provided a method of controlling an electronic device in a communication system comprising the electronic device and a wireless transmission tag, the method comprising the steps of detecting an external stimulus by the wireless transmission tag, activating a data transmission from the wireless transmission tag in response to the detection of the stimulus, receiving the data transmission by the electronic device, and initiating an operation of the electronic device in response to the receiving of the data transmission.

Such a method has the advantage that it enables the control over the instruction flow of the electronic device in response to the occurrence of an external event involving the electronic device. This way, the control over the electronic device is improved, because these instructions are now triggered at the desired moment in time instead of having to rely on a human interface.

In an embodiment of the method, the step of initiating an operation of the electronic device in response to the data processing comprises sending information over a network.

This has the advantage that the information, which may be a request for further information or may be a status update on a product to which the wireless transmission tag is fitted can be sent at the desired moment in time, which for instance allows for an accurate real-time monitoring of a product status outside the transmission range of the wireless transmission tag.

The invention is described in more detail and by way of non-limiting examples with reference to the accompanying drawings, wherein:

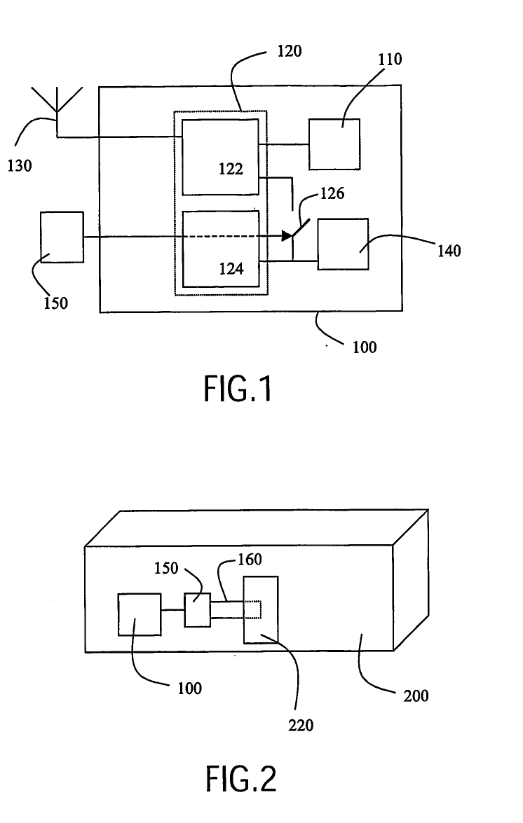

FIG. 1 schematically depicts a wireless transmission tag according to the present invention;

FIG. 2 schematically depicts a product tagged with a wireless transmission tag according to the present invention; and

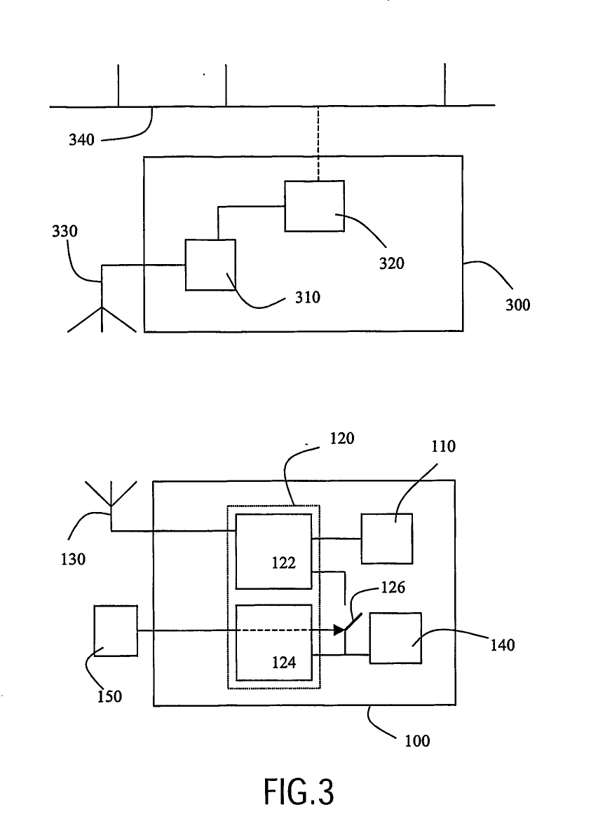

FIG. 3 schematically depicts an embodiment of a communication system is according to the present invention.

In FIG. 1, wireless communication tag 100 has a memory 110 coupled to control circuitry 120, which is coupled to an antenna 130. The memory 110 typically stores the data to be sent by the wireless communication tag 100 through its antenna 130, with the control circuitry 120 controlling the transmission of the data. The control circuitry 120 is coupled to a power source 140. In addition, the wireless communication tag 100 has a sensor 150 coupled to the power source 140, and which is arranged to activate the power supply to the at least a part of the control circuitry 120 upon the detection of an external stimulus, as symbolically depicted by a sensor 150 controlled switch 126 in the path from power source 140 to a first circuit portion 122 of the control circuitry 120. The sensor 150 may be an integral part of the wireless transmission tag 100, or may be an external device coupled to the wireless transmission tag 100. The sensor 150 may be coupled directly to the power source 140, or may be coupled to the power source 140 via a second circuit portion 124 of the control circuitry 120. The second circuit portion 124, which may be a digital circuit portion, typically is arranged to interpret the output of the sensor 150, and to control the power supply to the first circuit portion 122 of the control circuitry 120, which may be an analog circuit portion, in response to the output signal of the sensor 150. The first circuit portion 122 typically is arranged to control the transmission of data stored in the memory 110 via the antenna 130.

At this point, it is emphasized that the sensor 150 may be any known sensor, like a temperature sensor, a gas sensor, a pressure sensor, a biosensor and so on. In addition, it is pointed out that the wireless transmission tag 100 may additionally be arranged to receive transmissions without departing from the scope of the present invention.

The wireless transmission tag 100 according to the present invention can be used in a wide variety of applications where it may be desirable that the transmission of data from the wireless transmission tag 100 only takes place at predefined occasions. For example, it can be envisaged that more and more domestic products like groceries will be labelled with a wireless transmission tag 100 to enclose product related information in the memory of the wireless transmission tag 100. The use of the wireless tag 100 according to the present invention avoids unnecessary transmissions, which reduces the risk of interference with transmissions from other tags or sources sharing the same transmission frequency as wireless transmission tag 100.

A useful implementation may be the insertion of the wireless transmission tag 100 into the packaging of a food product, where the opening of the packaging of the food product will be sensed by sensor 150, for instance by the exposure of the sensor 150 to air, by having the sensor 150 detect a drop in packaging pressure or by the destruction of a conductive loop coupled to the sensor 150, to give just a few examples. The opening of the food product packaging is typically related to the consumption of the food product, at which point the information stored in the memory 110 of the wireless transmission tag 100 will become of interest to the consumer of the food product, for instance because the memory 110 contains preparation instructions for the food product. Thus, the data stored in the memory 110 is only delivered upon the external stimulus of opening the food packaging, and unnecessary transmission by the wireless transmission tag 100 is avoided. This not only saves power, which means that the capacity of the power source 140 can be reduced, but is also reduces the risk of the transmission of the wireless transmission tag 100 colliding or being confused with the transmission of another wireless transmission tag, because wireless transmission tag 100 will be silent when stored.

Other implementations may include the transmission of a warning signal by the wireless transmission tag 100, for instance in a situation where a food product has reached a certain temperature, which can be used to signal the conclusion of the preparation of the food product. It can also be used to signal that a food product has exceeded a certain temperature, for instance to signal that a disposable beverage container contains a beverage that is dangerously hot. Another application may be the sensing of the composition of a food product in order to warn potential consumers that the product contains a certain level of toxins, which can indicate the degradation of the food product beyond its suitability for consumption. In addition, non-food application domains can also benefit from sensor-activated wireless transmission tags 100. For instance, the rim of a car tyre can be fitted with a wireless transmission tag 100 having a pressure sensor 150 to signal a flat tyre. Many other applications can be thought of without departing from the teachings of the present invention.

FIG. 2 shows a product 200 that is fitted with a wireless transmission tag 100 coupled to a sensor 150. In the embodiment shown in FIG. 2, the sensor 150 has a conductive loop 160, which partially extends under a tear-off portion 220 of the product 200. By tearing off the tear-off portion 220, the conductive loop 160 will be destroyed, which is the external stimulus the sensor 150 is sensitive to. Thus, the destruction of the conductive loop 160 triggers the activation of the wireless transmission tag 100. This is particularly advantageous in applications where the product 200 is wrapped in a packaging that should remain intact during the use or preparation of product 200. This way, the wireless transmission tag 100 can be activated by the user of the product 200 without having to disturb the product 200 itself. Other embodiments of a product 200 having means for providing the external stimulus can be easily thought of; the product 200 may for instance have an airtight seal over the sensor 150 which can be pierced upon usage of the product 200. Alternatively, the product 200 may be fitted with a pressure sensor 150 coupled to the wireless transmission tag 100, which allows for activation of the wireless transmission tag 100 by means of applying pressure to the sensor, or by sensing a drop in pressure, as may be the case with the opening of pressurized food containers, in which case a substantial reduction in power consumption is obtained, because such products are typically intended for long-term storage, which may be several years. A further alternative may be a wireless transmission tag 100 coupled to an optical sensor 150, which is covered by a tear-off black-out foil or paper, and so on. It is once more stipulated that the sensor 150 may be an integral part of the wireless transmission tag 100 or may be an external device coupled to the wireless transmission tag 100, in which case the sensor 150 may be an integral part of the product 200.

The fact that the initiation of the transmission of the wireless transmission tag 100 typically coincides with the handling of a product that the wireless transmission tag 100 is fitted to can be utilized to trigger events in the devices that listen to the transmissions of the wireless transmission tag 100. An example of such a communication system is schematically depicted in FIG. 3, which is described in backreference to the previous Figs. and the accompanying detailed descriptions. Similar reference numerals have similar meanings unless explicitly stated otherwise. In FIG. 3, communication system 10 includes the wireless transmission tag 100 of the present invention and an electronic device 300. The electronic device is fitted with a receiver 310, which typically includes an antenna 330 for receiving data transmitted by the wireless transmission tag 100 and a processing unit 320, which is responsive to the receiver 310. Optionally, the electronic device may be coupled to a wired or wireless network 340 like an in-home network or an external like a phone line or the internet via its processing unit 320 or via the receiver 310.

The operation of the communication system 10 is typically based on the following method. In a first step, an external stimulus is detected by the sensor 150 that is coupled to the wireless transmission tag 100, which in a subsequent step activates the data transmission from the wireless transmission tag 100 in response to the detection of the stimulus by the sensor 150. This data transmission will be received by the electronic device 300 via its receiver 310 and will be forwarded to the processing unit 320 of the electronic device 300, which processes the received data for the purpose of initiating an operation of the electronic device 300 that relates to the external stimulus.

The electronic device 300 of communication system 10 may for instance be an oven or a microwave oven fitted with a receiver 310 coupled to its processing unit 320. The wireless transmission tag 100 may be fitted to a food packet to be prepared in the electronic device 300, with the sensor 150 being arranged to either transmit cooking instructions to the electronic device 300 upon activation of the wireless transmission tag 100 by a user, or with the sensor 150 being arranged to sense an internal temperature of the food packet, in which case the wireless transmission tag 100 will be activated when the food in the food packet reaches a predefined temperature indicating that the food processing is completed. The memory of the wireless transmission tag 100 may store an instruction for switching off the electronic device 300, which will be transmitted upon detecting of the intended external stimulus. It will be obvious to those skilled in the art that this concept can be extended to a wide variety of other domestic appliances such as juicers, blenders, coffee makers and so on.

In another example, the electronic device 300 is coupled to a display that displays the data received from the wireless transmission tag 100. Such an electronic device may be a storage device like a refrigerator, which, upon receipt of the data transmitted by the wireless transmission tag 100, provides the display with information of products in the refrigerator that, for instance, have become contaminated by toxins. This can prevent the potential consumers of these products from actually consuming the contaminated products.

In an alternative example of communication system 10, the wireless transmission tag 100 is attached to a medication container, with the sensor 150 sensing the opening of the container. The opening of the container typically coincides with the initiation of the treatment of a patient, and this external stimulus, that is, the opening of the container, may be used to provide an electronic device 300 with data indicating the start of the treatment and the intake frequency of the medication, which can be used to program the electronic device 300 to timely notify the patient, for instance by means of a display message or an audible signal or a combination of both, that the next intake of the medication is due. The electronic device 300 may be any electronic device fitted with an alarm function, like an alarm clock, a watch, a radio and so on.

In a further example of communication system 10, the electronic device 300 may be a device with an output like an optical output for triggering the sensor 150, which triggers the transmission of data by the wireless transmission tag 100. Such an electronic device 300 may for instance be a hand-held scanner or a bar-code reader in a supermarket. The data stored in the memory 110 of the data transmission tag 100 may include a list of contents of the product that the wireless transmission tag 100 is fitted to, which will be received by the receiver 310 of the electronic device 300 and can be displayed on a display coupled to the electronic device 300 to inform the intended buyer or user of the product of the contents of the product. The display of this data may be preceded by a processing step of the data in the processor 320 of the electronic device 300, in which the data received from the wireless transmission tag 100 is compared with personal data from the intended buyer or user of the product. This personal data may be stored in another wireless transmission tag carried by the intended buyer or user, or may be retrieved from a database that is either localized in the electronic device 300 or is accessible via a network 340. This way, the intended buyer or user can for instance be warned that the product contains ingredients that the intended buyer of user is allergic to.

In many cases, the detection of the external stimulus by the sensor 150 signals correlates with the use or consumption of the product that the wireless transmission tag 100 is fitted to. Therefore, the detection of the external stimulus by the sensor 150 also correlates with a reduction in the number of items of that particular product that is being kept in stock. Consequently, communication system 10 can be configured as a stock monitor, in which electronic device 300 has access to a database, where the numbers of various products currently in stock are registered. The transmitted data of the wireless transmission tag 100 typically comprises a product identifier, which is recognized by the processing unit 320, which subsequently updates the number of items of this particular product in the database. The information in the database can be used to generate automated shopping lists, to ensure that certain key products are kept in stock. The database may be accessible to the electronic device 300 via a network 340, and may be located in-house, for instance on a computer coupled to an in-home network, or may be located at a remote address, for instance at the computer of a supermarket, in which case an automated grocery delivery service can be initiated by the detection of the external stimulus by the sensor 150. Also non-food items that have to be kept in stock can be monitored this way; for instance the supply of key medication to patients, like a diabetes patient or a HIV infected patient can be regulated this way. It is emphasized that such methods are not feasible with the prior art wireless transmission tags, because no distinction can be made between the data transmitted by a wireless transmission tag of a non-used product and the wireless transmission tag of a used product.

The fact that the detection of the external stimulus by the sensor 150 can coincide with the consumption or preparation of a food product can also be utilized to provide the user of the food product with preparation suggestions. The detection of the wireless transmission tag 100 data transmission by the electronic device 300 may be used to trigger the electronic device 300 to investigate which products are in stock. This can be done by accessing the aforementioned stock database or, if conventional tags, that is, non-sensor tags, are also present within the realm of the communication system 10, initiate a scan to detect the presence of the product fitted with the conventional tags. The list of detected products can be used to provide the user of the food product in preparation with recipe suggestions, which may be retrieved from a database that may be accessible via the network 340.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A wireless transmission tag having:
a memory;
control circuitry coupled to the memory;
an antenna coupled to the control circuitry; and
a power source for powering the control circuitry,
the power source being coupled to a sensor for activating a power supply from the power source to at least a part of the control circuitry responsive to an external stimulus.

2. A wireless transmission tag as claimed in claim 1, wherein the sensor is coupled to the power source via the control circuitry, and the control circuitry comprises:
a first circuit portion for controlling a data transfer from the memory to the antenna; and
a second circuit portion for activating a power supply from the power source to the first circuit portion in response to an output signal of the sensor.

3. A product tagged with a wireless transmission tag having a memory, control circuitry coupled to the memory, an antenna coupled to the control circuitry, and a power source for powering the control circuitry, the power source being coupled to a sensor for activating a power supply from the power source to at least a part of the control circuitry responsive to an external stimulus, the product comprising means for triggering the external stimulus.

4. A communication system comprising:
a product tagged with a wireless transmission tag having: a memory;
control circuitry coupled to the memory;
an antenna coupled to the control circuitry; and
a power sources for powering the control circuitry; the power source being coupled to a sensor for activating a power supply from the power source to at least a part of the control circuitry responsive to an external stimulus; and
an electronic device comprising a processing unit and a receiver coupled to the processing unit, the processing unit being arranged to perform an operation relating to the external stimulus responsive to the reception by the receiver of data being transmitted by the wireless tag upon detection of the external stimulus.

5. A communication system as claimed in claim 4, wherein the electronic device is coupled to a network, and the operation comprises sending information over the network.

6. A method of controlling an electronic device in a communication system comprising the electronic device and a wireless transmission tag,
the method comprising the steps of:
detecting an external stimulus by a sensor coupled to the wireless transmission tag;
activating a data transmission from the wireless transmission tag in response to the detection of the stimulus;
receiving the data transmission by the electronic device; and
initiating an operation of the electronic device relating to the external stimulus in response to the reception of the data transmission.

7. A method as claimed in claim 6, wherein the step of initiating an operation of the electronic device relating to the external stimulus in response to the reception of the data transmission comprises sending information over a network.
